(19) United States
(12) Patent Application Publication
(10) Pub. No.: US 2026/0036849 A1
(43) Pub. Date: Feb. 5, 2026

(54) DISPLAY PANEL AND DISPLAY DEVICE COMPRISING THE SAME

(71) Applicant: LG DISPLAY CO., LTD., Seoul (KR)

(72) Inventors: Sang Pyo HONG, Paju-si (KR); Seung Han PAEK, Paju-si (KR); Hyun Jin AN, Paju-si (KR); Seong Woo PARK, Paju-si (KR)

(73) Assignee: LG DISPLAY CO., LTD., Seoul (KR)

(21) Appl. No.: 18/968,560

(22) Filed: Dec. 4, 2024

(30) Foreign Application Priority Data
Jul. 30, 2024 (KR) 10-2024-0100626

(51) Int. Cl. G02F 1/1339; G02F 1/133; G02F 1/1333

(52) U.S. Cl. CPC G02F 1/1339; G02F 1/133357; G02F 1/13306

(57) ABSTRACT

A display panel may include a first substrate having a first etching surface, a second substrate disposed to face the first substrate, and a sealant disposed between the first substrate and the second substrate. The sealant may be disposed in an outer area of the first etching surface. A display device including the display panel is also disclosed. According to one or more aspects of the display panel, damage to the display device can be prevented or reduced from a spraying pressure caused by an etching fluid sprayed toward a substrate.

### CROSS-REFERENCE TO RELATED APPLICATION

This application claims the benefit of and priority to Korean Patent Application No. 10-2024-0100626, filed in the Republic of Korea on Jul. 30, 2024, the entire contents of which are incorporated herein by reference for all purposes.

### BACKGROUND

### 1. Technical Field

The present specification relates to a display panel and a display device including the same.

### 2. Discussion of the Related Art

In general, display devices are widely used as display screens in various electronic devices such as mobile communication terminals, electronic notebooks, e-books, portable multimedia players (PMPs), navigation systems, ultra-mobile PCs (UMPCs), mobile phones, tablet personal computers (PCs), watch phones, electronic pads, wearable devices, portable information devices, vehicle control display devices, televisions, laptops, and monitors.

Recently, research and development has been conducted to bend a non-display area in which images are not displayed in the same display panel size and dispose driving IC chips and the like on a rear surface of a display device.

The description provided in the background section should not be assumed to be prior art merely because it is mentioned in or associated with the background section. The background section may include information that describes one or more aspects of the subject technology.

The description of the related art should not be assumed to be prior art merely because it is mentioned in or associated with this section. The description of the related art includes information that describes one or more aspects of the subject technology, and the description in this section does not limit the invention.

### SUMMARY

An aspect of present specification is to provide a display panel and a display device including the same that substantially obviate one or more of the issues due to limitations and disadvantages of the related art.

Features and aspects of the present specification are not limited to the above-described aspect, and other features and aspects not described will be clearly understood by those skilled in the art from the following description, or may be realized and attained by the structures pointed out in the present disclosure, or derivable therefrom, and the claims hereof as well as the appended drawings.

To achieve these and other aspects of the inventive concepts, as embodied and broadly described herein, a display panel according to the present specification may include a first substrate including a first etching surface, a second substrate disposed to face the first substrate, and a sealant disposed between the first substrate and the second substrate, wherein the sealant may be disposed in an outer area of the first etching surface.

A display panel according to the present specification may include a first substrate including a bending area and a display area including a thin film transistor, a second substrate disposed to face the first substrate, an etch stop layer disposed in the bending area, and a sealant disposed between the first substrate and the second substrate, wherein the sealant may include a first sealant disposed in the display area, and a second sealant disposed between the etch stop layer and the second substrate.

A display device according to the present specification may include a display area for displaying an image, a driving circuit area including a driving circuit for driving the display area, and a non-display area including a bending area disposed to extend in a first direction, wherein the bending area may include an etch stop layer disposed to extend in the first direction and a separating layer disposed to extend in the first direction, and the separating layer may include a concave portion disposed to extend in the first direction.

According to the present specification, damage to a display device can be prevented or reduced from a spraying pressure caused by an etching fluid sprayed toward a substrate in a direction in which the display device is disposed.

According to the present specification, the likelihood of an etch stop layer being torn due to the spraying pressure can be reduced.

According to the present specification, components disposed above the etch stop layer can be protected from the etching fluid.

According to the present specification, since damage to the display device can be prevented or reduced in an etchant spraying process, production energy can be reduced and the process can be optimized.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, that may be included to provide a further understanding of the disclosure and may be incorporated in and constitute a part of the disclosure, illustrate embodiments of the disclosure and together with the description serve to explain various principles of the disclosure.

The above and other aspects, features and effects of the present disclosure will become more apparent to those of ordinary skill in the art by describing example embodiments thereof in detail with reference to the accompanying drawings, in which:

FIG. 1 is a perspective view showing a display device before bending according to an example embodiment of the present specification;

FIG. 2 is a plan view showing a display device according to an example embodiment of the present specification;

FIG. 3 is a plan view showing a display device according to another example embodiment of the present specification;

FIG. 4 is an example of a partial enlarged view of portion A of FIG. 3;

FIG. 5 is an example of a cross-sectional view along line I-I′ of FIG. 4;

FIG. 6 is a cross-sectional view showing a display device in a bent state according to an example embodiment of the present specification;

FIG. 7 is a cross-sectional view showing a display device in an unbent state according to an example embodiment of the present specification;

FIG. 8 is an example of an enlarged plan view of portion P of FIG. 6;

FIG. 9 is an example of a cross-sectional view along line A-A′ of FIG. 8;

FIG. 10 is an example of a cross-sectional view of portion Q of FIG. 7 from another direction;

FIG. 11 is an example of a cross-sectional view of portion R of FIG. 7 from another direction;

FIG. 12 is a cross-sectional view showing a display device before bending according to an example embodiment of the present specification;

FIG. 13 is a cross-sectional view showing a display device before bending according to an example embodiment of the present specification;

FIGS. 14A to 14C are a set of views for describing an etching process in a manufacturing method of the display device according to an example embodiment of the present specification;

FIG. 15 is a plan view showing a mother glass according to an example embodiment of the present specification; and

FIGS. 16 to 33 are views for describing a manufacturing method or manufacturing process of the display device according to an example embodiment of the present specification.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or briefly provided. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Advantages and features of the present disclosure, and methods of achieving them, will become clear by referring to example embodiments described in detail below along with accompanying drawings. The present disclosure is not limited to the example embodiments disclosed below but can be implemented in various different forms. These example embodiments are merely provided to make the disclosure of the present disclosure complete and fully inform those skilled in the art to which the present disclosure pertains of the scope of the present disclosure, and the present disclosure is only defined by the scope of the appended claims.

The shapes, sizes, ratios, angles, numbers, and the like, which are illustrated in the drawings to describe various example embodiments of the present disclosure are merely given by way of example. Therefore, the present disclosure is not limited to the illustrations in the drawings. The same or similar elements are designated by the same reference numerals throughout the specification unless otherwise specified. In the following description where the detailed description of the relevant known function or configuration may unnecessarily obscure an important point of the present disclosure, a detailed description of such known function of configuration may be omitted or briefly provided. Any implementation described herein as an “example” is not necessarily to be construed as preferred or advantageous over other implementations.

In construing an element, the element is construed as including an error range or tolerance range although there is no explicit description of such an error or tolerance range.

When the terms “comprise,” “include,” “have,” and “consist of” described in the present specification are used, other parts may be added unless a term such as “only” is used. When a component is expressed in singular, it may be interpreted as plural unless otherwise specifically stated.

When the positional relationship or the interconnected relationship between two components such as “on,” “over,” “under,” “above,” “below,” “beneath,” “near,” “close to,” or “adjacent to,” “beside,” “next to,” “connect or couple,” “crossing,” or “intersecting” is described, one or more other components may be interposed between the components unless a more limiting term, such as “immediately,” “closely” or “directly” is used. Furthermore, the terms “left,” “right,” “top,” “bottom,” “downward,” “upward,” “upper,” “lower,” and the like refer to an arbitrary frame of reference.

When the temporal relationship such as “after,” “following,” “next,” or “before” is described, it may not be continuous on the time axis unless a more limiting term, such as “just,” “immediately” or “directly” is used.

“First,” “second,” “A,” “B,” “(a),” and “(b),” etc. may be used to distinguish components from each other, but the function or structure of the components is not limited by the ordinal number in front of the components or the component name. Also, when an element or layer is described as being “connected,” “coupled,” or “adhered” to another element or layer, the element or layer can not only be directly connected, or adhered that other element or layer, but also be indirectly connected, or adhered that other another element or layer with one or more intervening elements or layers disposed between the elements or layers, unless otherwise specified.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Features of the following embodiments may be partially or fully coupled or combined with each other, and various ways of technological interworking and driving are possible. The embodiments may be implemented independently of each other and implemented together in an associated relationship.

Unless otherwise defined, all terms (including technical and scientific terms) used in embodiments of the present specification may be interpreted as meanings that may be generally understood by those skilled in the art to which the present specification pertains unless explicitly specifically defined and described, and the meanings of the commonly used terms, such as terms defined in a dictionary, may be interpreted in consideration of contextual meanings of the related technology and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

In a display device according to the present specification, a pixel circuit and a gate driving circuit may include a plurality of transistors. The transistors may be an oxide TFT containing an oxide semiconductor or a low temperature poly silicon (LTPS) TFT including LTPS, but the present disclosure is not limited thereto.

The transistor is a three-electrode element including a gate, a source, and a drain. The source is an electrode that supplies carriers to the transistor. In the transistor, the carriers begin to flow from the source. The drain is an electrode from which the carriers exit the transistor. In the transistor, carriers flow from the source to the drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (for example, p-channel metal-oxide semiconductor (PMOS)), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode respectively, and vice versa.

A ‘line’ mentioned in embodiments of the present disclosure may be interpreted as a wire to which a signal or a voltage is applied.

Hereinafter, example embodiments of the present disclosure will be described in detail with reference to the accompanying drawings.

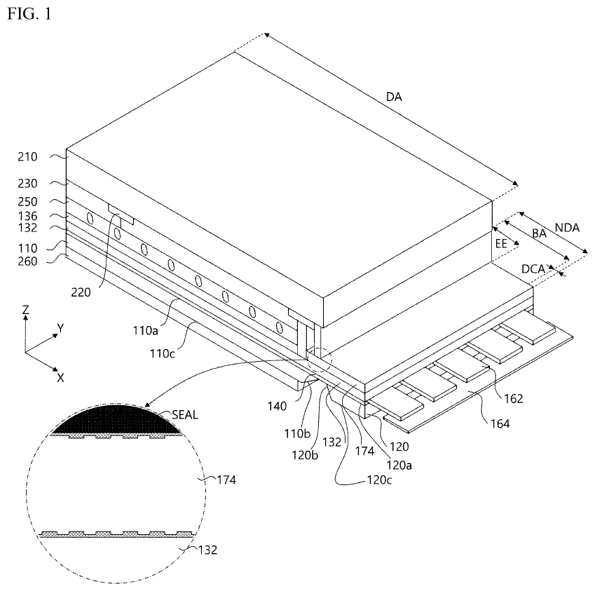

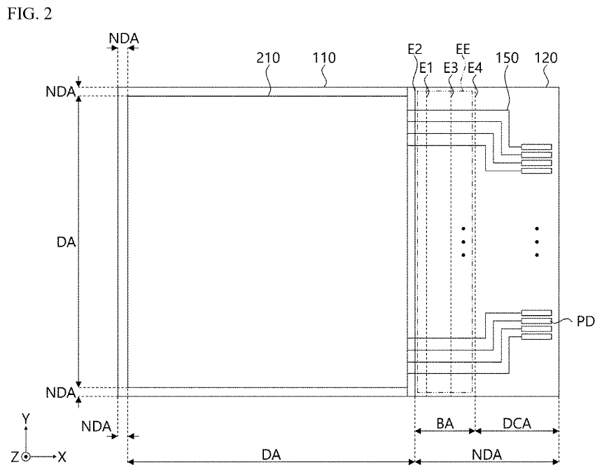

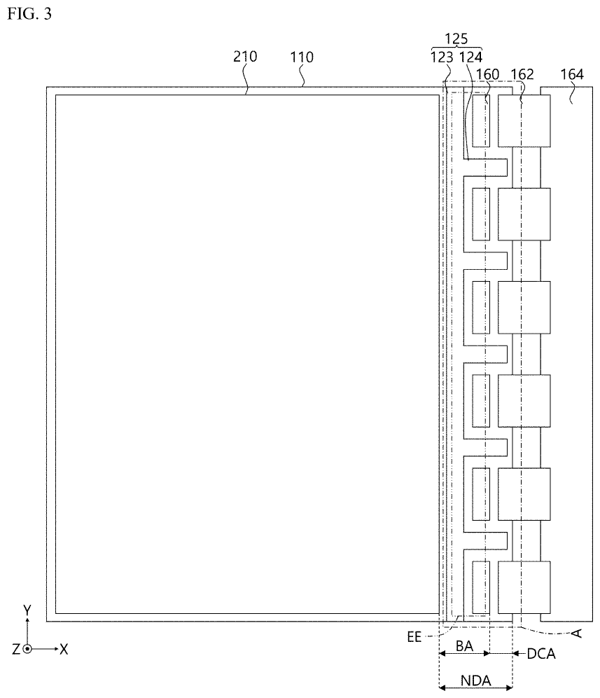

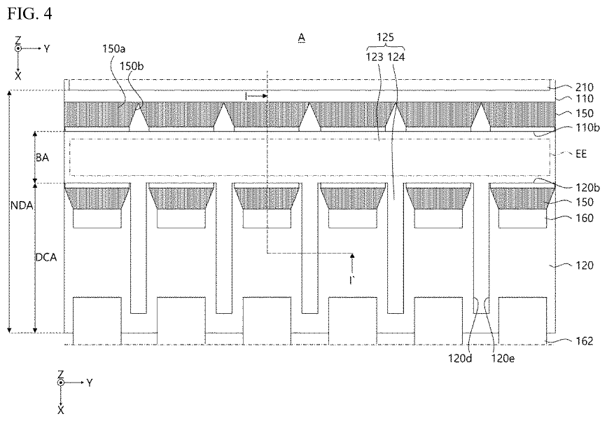

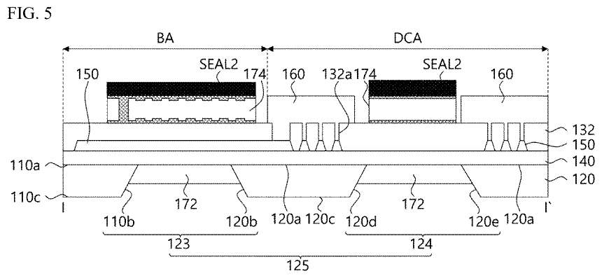

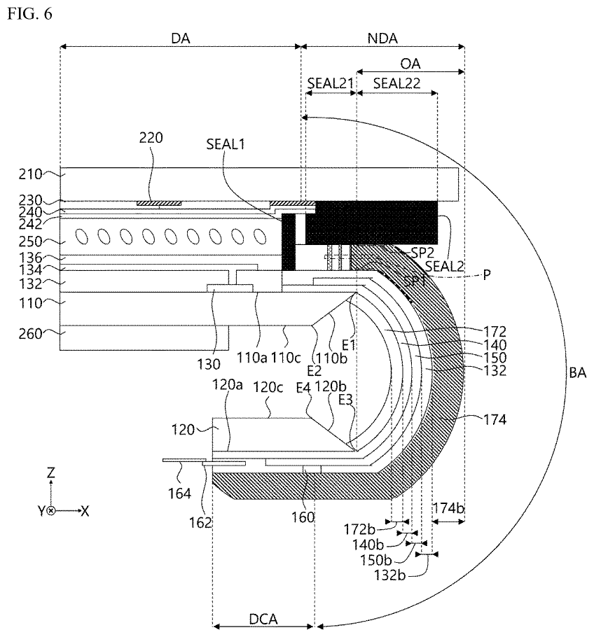

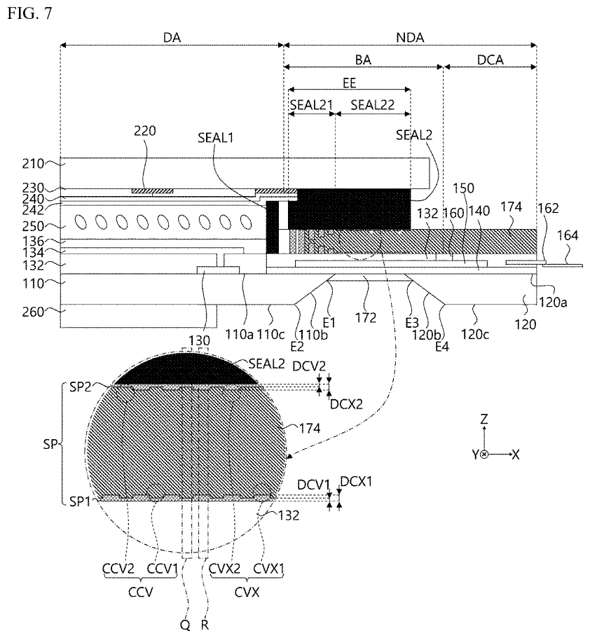

FIG. 1 is a perspective view showing a display device before bending according to an example embodiment of the present specification. FIG. 2 is a plan view showing a display device according to an example embodiment of the present specification. FIG. 3 is a plan view showing a display device according to another embodiment of the present specification. FIG. 4 is a partial enlarged view of portion A of FIG. 3. FIG. 5 is a cross-sectional view along line I-I′ of FIG. 4. FIG. 6 is a cross-sectional view showing a display device in a bent state according to an example embodiment of the present specification. FIG. 7 is a cross-sectional view showing a display device in an unbent state according to an example embodiment of the present specification.

As the display device of the present specification, a liquid crystal display (LCD) device, a plasma display panel (PDP) device, a field emission display (FED) device, an electroluminescence display (ELD) device, an organic light emitting diode (OLED) device, etc. may be used, but in the present specification, an LCD device that uses a backlight unit or micro-LED as a light source will be described as an example among the display devices. However, the present specification is not limited thereto.

Referring to FIGS. 1, 3, 5, 6, and 7, the display device according to an example embodiment of the present specification may include a first substrate 110 and a second substrate 210 that are disposed to face each other vertically with a predetermined gap in a display area DA. The display device may include a light source unit 260 disposed under the first substrate 110 to emit light upward (e.g., in a Z-axis direction) from the first substrate 110.

From another perspective, the display device may include the display area DA, a bending area BA, and a non-display area NDA including a driving circuit area DCA. The bending area BA may include a reinforced area EE.

The substrates 110 and 120 may be partitioned into a plurality of substrates by the bending area BA. For example, the substrates 110 and 120 may include the first substrate 110 including the display area DA and a dummy substrate 120 disposed with the bending area BA interposed between the dummy substrate 120 and the first substrate 110 in a state before bending.

The substrates 110, 120, and 210 may include a glass material. The first substrate 110 and the dummy substrate 120 according to an example embodiment may have a thickness of 0.01 mm to 1.0 mm to maintain the flatness of a first flat surface 110a and a second flat surface 120a or to prevent or reduce moisture or oxygen from penetrating into the display device, but are not limited thereto.

The first substrate 110 may include a first etching surface 110b disposed to overlap the bending area BA. The first substrate 110 may further include the first flat surface 110a and a first rear surface 110c facing the first flat surface.

The dummy substrate 120 may include a second etching surface 120b disposed to overlap the bending area BA. The dummy substrate 120 may further include the second flat surface 120a and a second rear surface 120c facing the second flat surface 120a.

The first etching surface 110b may overlap the bending area BA in a planar direction of the display device. The second etching surface 120b may overlap the bending area BA in the planar direction of the display device. The first etching surface 110b may be formed in a direction (e.g., an X-axis direction) in which the second etching surface 120b is formed. The second etching surface 120b may be formed in a direction in which the first etching surface 110b is formed. At least a portion of the display device may be bent by the first etching surface 110b and the second etching surface 120b.

A thin film transistor (TFT) 130 including a gate electrode, an active layer, a source electrode, and a drain electrode may be formed on the first flat surface 110a.

An interlayer insulating film or a planarization layer 132 may be formed on the first flat surface 110a. A pixel electrode 134 electrically connected to the thin film transistor 130 through a contact hole (not shown) may be formed on the planarization layer 132. A first alignment layer 136 and a second alignment layer 242 may be formed on the pixel electrode 134 to facilitate the arrangement of liquid crystals.

A liquid crystal layer 250 may be formed in an area in which a uniform cell gap is formed between the first alignment layer 136 and the second alignment layer 242. The liquid crystal layer 250 may include liquid crystals having optical anisotropic properties. A voltage may be applied through the pixel electrode 134 and a common electrode 240 disposed on the second alignment layer 242 to the display device. Accordingly, the liquid crystal cell may be driven to display an image.

The common electrode 240 disposed on the second alignment layer 242 may be formed of a transparent conductive material. The common electrode 240 may be formed of indium tin oxide (ITO) or indium zinc oxide (IZO). The common electrode 240 has been described as being disposed on the second substrate 210, but is not limited thereto. For example, the common electrode 240 may be formed on the first substrate 110. More specifically, the common electrode 240 may be formed on the same layer as the pixel electrode 134. Alternatively, the common electrode 240 may be disposed between the pixel electrode 134 and the first substrate 110 or disposed between the pixel electrode 134 and the first alignment layer 136.

A spacer (not shown) that serves to maintain a uniform cell gap may further be formed between the first substrate 110 and the second substrate 210. In an example embodiment, the cell gap may be several micrometers. For example, the cell gap may range from 1 μm to 10 μm.

A black matrix 220 may be formed on the second substrate 210 of the display area DA at a predetermined interval. The black matrix 220 may have a closed loop shape surrounding the display area DA to block light leakage. In addition, the black matrix 220 may be disposed to correspond to an area in which the TFT 130, a gate line (not shown), and a data line (not shown) of the first substrate 110 are disposed to block light leakage. Therefore, the black matrix 220 may be arranged in a matrix form. The black matrix 220 may be provided between color filter layers 230 to prevent or reduce color mixing between the color filter layers 230.

The color filter layers 230 of red (R), green (G), and blue (B) that filter only light of a specific wavelength band may be provided between the black matrixes 220. The color filter layer 230 may include an acrylic resin and a pigment. The color filter layer 230 may be classified into red (R), green (G), and blue (B) depending on the type of pigment used to implement a color.

An overcoat layer (not shown) may be further formed on the black matrix 220 and the color filter layer 230. The overcoat layer (not shown) may be provided to protect the color filter layer 230, planarize a surface, and increase bonding strength with the common electrode 240, and may include an acrylic resin.

A first sealant SEAL1 may be disposed between the first substrate 110 and the second substrate 210. The first and second substrates 110 and 210 may be bonded by the first sealant SEAL1.

The first sealant SEAL1 may be disposed on the planarization layer 132 and disposed between the planarization layer 132 and the black matrix 220. The first sealant SEAL1 may include a photocurable, heat-curable, or UV-curable epoxy resin. The first sealant SEAL1 may serve to form a gap for injecting liquid crystals and prevent or reduce leakage of the injected liquid crystals. The first sealant SEAL1 may be formed by forming a predetermined resin in a regular pattern on the first substrate 110, arranging the second substrate 210 on the first substrate 110, and bonding the two substrates 110 and 210 through pressing and curing. However, the first sealant SEAL1 is not limited thereto, and a second sealant SEAL2 to be described below may be substantially the same as or similar to the first sealant.

Referring to FIGS. 2 to 7, the display area DA is an area in which images are displayed and may include a plurality of pixels. The plurality of pixels may be arranged in a matrix form, and each of the plurality of pixels may include sub-pixels. The display area DA may have a substantially rectangular shape. However, the display area DA is not limited thereto and may have any polygonal shape. Alternatively, the display area DA may have a triangular, pentagonal, or hexagonal shape. For convenience of explanation in the present specification, the display area DA will be described as having a rectangular shape.

The non-display area NDA may be an area surrounding the display area DA. An element and a circuit wiring for driving the display area DA may be arranged in the non-display area NDA.

The bending area BA may be defined as an area disposed so that a portion of the display device may be bent. Therefore, the display device may be folded to have a predetermined radius of curvature according to the bending of the bending area BA.

A first end E1 of the first substrate 110 may be defined as a boundary between the first flat surface 110a and the first etching surface 110b. A second end E2 of the first substrate 110 may be defined as a boundary between the first etching surface 110b and the first rear surface 110c.

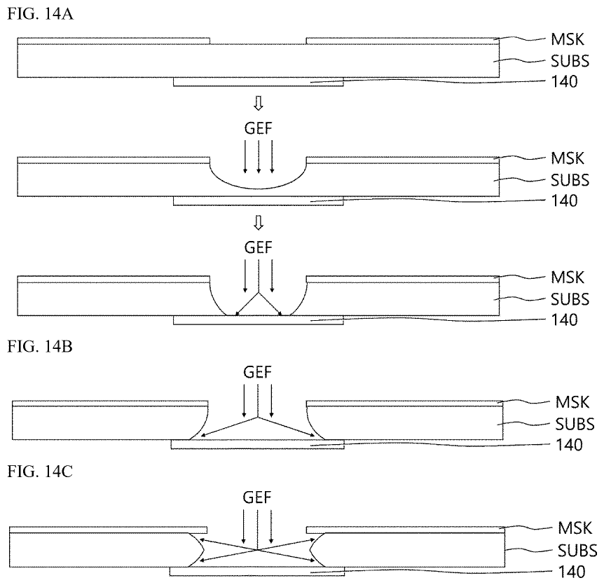

A slope of the first etching surface 110b may be defined by a sloped surface connecting the first end E1 to the second end E2. The first etching surface 110b may have a convex curved surface as shown in FIGS. 14A to 14C, but is not limited thereto.

A third end E3 of the dummy substrate 120 may be defined as a boundary between the second flat surface 120a and the second etching surface 120b. A fourth end E4 of the dummy substrate 120 may be defined as a boundary between the second etching surface 120b and the second rear surface 120c.

A slope of the second etching surface 120b may be defined by a sloped surface connecting the third end E3 to the fourth end E4. The second etching surface 120b may have a convex curved surface as shown in FIGS. 14A to 14C, but is not limited thereto.

A quadrangular shape defined by the first to fourth ends E1, E2, E3, and E4 may have a substantially regular tapered shape, but is not limited thereto. The regular tapered shape means that a distance between the second end E2 and the fourth end E4 is longer than a distance between the first end E1 and the third end E3, as shown in FIG. 5 corresponding to FIGS. 2 and 3.

The display device according to an example embodiment of the present specification may include a link line 150 that is formed on an etch stop layer 140 and formed to overlap the non-display area NDA.

The driving circuit area DCA may be located on the dummy substrate 120. A plurality of link lines 150 forming unit blocks, driving circuits 160 connected thereto, and a plurality of flexible printed circuits (FPCs) 162 connected to the driving circuits 160 may be disposed in the driving circuit area DCA.

The driving circuits 160 may be electrically connected to the plurality of link lines 150. Referring to FIG. 5, the driving circuit 160 may be connected by coming into contact with each of the plurality of link lines 150 through one of a plurality of link line contact holes 132a formed in the planarization layer 132.

Since multiple elements such as integrated circuits are formed on a printed circuit board (PCB) 164, various control signals and data signals for driving the display device may be generated.

Referring to FIGS. 4 and 5, a bending etching portion 125 may be formed under the first substrate 110 and the dummy substrate 120. The bending etching portion 125 may include a first bending etching portion 123 and a second bending etching portion 124.

The first bending etching portion 123 may be formed in a first direction (e.g., a Y-axis direction) in which the bending area BA is disposed to extend. The first bending etching portion 123 may include the first etching surface 110b formed on a bottom surface of the first substrate 110 and the second etching surface 120b formed on a bottom surface of the dummy substrate 120.

The second bending etching portion 124 may be located to overlap the driving circuit area DCA located on the dummy substrate 120 and may be formed on the bottom surface of the dummy substrate 120 between the link lines 150 forming unit blocks. The first bending etching portion 123 and the second bending etching portion 124 may be integrally formed to have a continuous surface and may be connected.

The second bending etching portion 124 may be formed to intersect the first bending etching portion 123 disposed in the first direction (e.g., the Y-axis direction) so as to have a continuous surface with the first bending etching portion 123. Therefore, the second bending etching portion 124 may be disposed to extend in a second direction (e.g., the X-axis direction) intersecting the first direction (e.g., the Y-axis direction). The second bending etching portion 124 may be formed in each area between the link lines 150 forming unit blocks.

The second bending etching portion 124 may include a third etching surface 120d and a fourth etching surface 120e that are formed on the bottom surface of the dummy substrate 120. The second bending etching portion 124 is located in the driving circuit area DCA between the plurality of FPCs 162, and thus, may not overlap the link lines 150 forming unit blocks.

The etch stop layer 140 may be formed on the bending area BA and the driving circuit area DCA that overlap the first bending etching portion 123 and the second bending etching portion 124. The plurality of link lines 150 may be formed on the etch stop layer 140. A portion of the planarization layer 132 formed on the display area DA may be formed on the plurality of link lines 150.

Referring to FIGS. 4 and 5, the display device according to an example embodiment of the present specification may include the etch stop layer 140 disposed to overlap the bending etching portion 125.

The etch stop layer 140 may be disposed to overlap the bending area BA of the display device.

As shown in FIG. 6, at least a portion of the etch stop layer 140 may overlap the first flat surface 110a in the planar direction of the display device. At least a portion of the etch stop layer 140 may overlap the second flat surface 120a in the planar direction of the display device.

Considering a process margin for forming the first etching surface 110b and the second etching surface 120b, the etch stop layer 140 may be formed to overlap an area extending to one side (e.g., the X-axis direction) and the other side of the bending area BA.

The etch stop layer 140 may be formed to overlap the first flat surface 110a of the first substrate 110 and the second flat surface 120a of the dummy substrate 120 by a predetermined area. The etch stop layer 140 may have a size greater than that of an area overlapping the first etching surface 110b and the second etching surface 120b of the first substrate 110 and the dummy substrate 120, or greater than that of the bending area BA.

Accordingly, the stability of an etching process for forming the first etching surface 110b and the second etching surface 120b can be improved.

The etch stop layer 140 may be formed by spraying a material on a set location in a mechanical manner such as a slit coater, an inkjet, or a dispenser. Alternatively, the etch stop layer 140 may be formed through a patterning process using a photolithography mask. The etch stop layer 140 may be defined as an etching stop pattern, etching barrier pattern, etching mask pattern, etc.

The etch stop layer 140 may be formed of a material that is corrosion resistant (or resistant) to an etching fluid (etchant) used in an etching process (for example, a glass etching process). The etch stop layer 140 may be formed of a material resistant to a glass etching fluid, but the present disclosure is not limited thereto.

The etch stop layer 140 may include a metal or an organic material. The etch stop layer 140 may include at least one of silicone-based organic materials, urethane, polyimide, and photoacrylic. The etch stop layer 140 may include at least one of chromium (Cr), aluminum (Al), platinum (Pt), gold (Ag), molybdenum (Mo), and nickel (Ni).

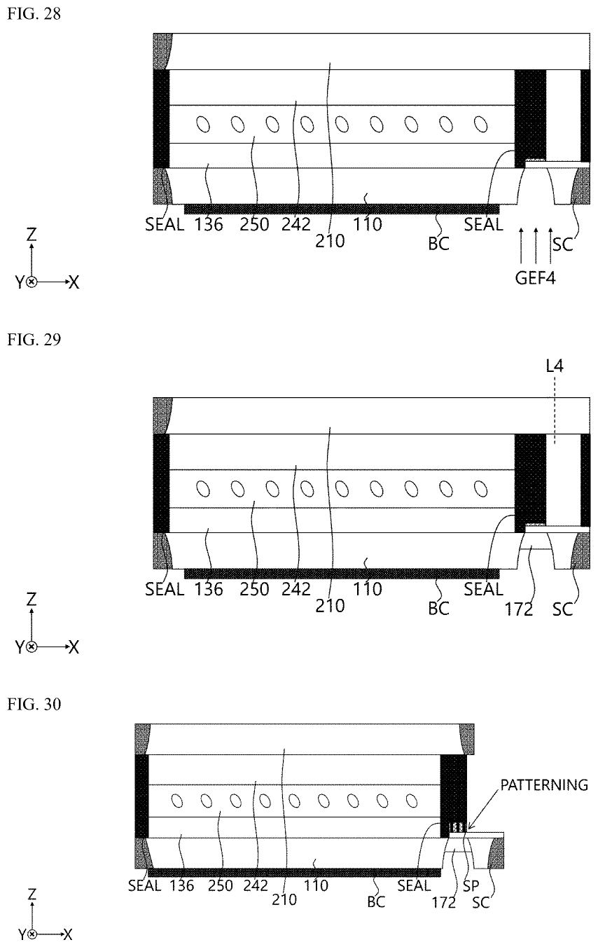

The etch stop layer 140 may prevent or reduce the display device from being damaged by the etching fluid. As described below with reference to FIG. 29, a second coating layer 172 may be formed after a hole is created by an etching process according to FIG. 28. The etch stop layer 140 may protect components located above (e.g., the Z-axis direction) during a process of forming the first etching surface 110b and the second etching surface 120b of the first substrate 110 and the dummy substrate 120 (see FIG. 28, before the second coating layer 172 is formed).

An inorganic film may be formed under the etch stop layer 140 to increase the bonding strength with the substrates 110 and 210 and supplement the thickness. Alternatively, a stacked structure of an inorganic film and a metal film may be formed.

A gate insulating film or an interlayer insulating film used when forming a thin film transistor may be applied as the inorganic film. As the inorganic film, silicon nitride (SiNₓ), silicon oxide (SiOₓ), or the like may be used.

A metal layer used when forming a gate electrode or source/drain electrodes may be applied as the metal film. As the metal film, molybdenum (Mo), MoTi, ITO, or the like may be used.

The second coating layer 172 may be formed under the etch stop layer 140 overlapping the first bending etching portion 123 and the second bending etching portion 124.

Micro coating layers (MCLs) 172 and 174 may be formed above or under the planarization layer 132 formed on the etch stop layer 140 overlapping the first bending etching portion 123 and the second bending etching portion 124. The coating layers 172 and 174 may include a first coating layer 174 formed above the etch stop layer 140 and the second coating layer 172 formed under the etch stop layer 140. A thickness of the first coating layer 174 may be several tens of micrometers. For example, the thickness of the first coating layer 174 may range from 10 μm to 100 μm, or from 20 μm to 90 μm, specifically, from 30 μm to 80 μm, or from 50 μm to 60 μm and more specifically, about 55 μm.

When the first substrate 110 and the dummy substrate 120 are bent, a tensile force may act on the link line 150 disposed on the etch stop layer 140, thereby causing cracks. The first coating layer 174 and the second coating layer 172 may serve to protect wirings by forming a thin resin at the bent location. The coating layers 172 and 174 may include an acrylic-based material containing an acrylate polymer. In another embodiment, the coating layers 172 and 174 may include an UV-curable epoxy resin.

The coating layers 172 and 174 may adjust a neutral plane of the bending area BA. The neutral plane may be an imaginary plane that does not receive stress because the compressive force and tensile force applied to a structure are offset with each other when the structure is bent. When two or more structures are stacked, an imaginary neutral plane may be formed between the structures.

When the entire structure bends in one direction, the structures disposed in a bending direction with respect to the neutral plane are compressed by bending, and thus receive a compressive force. On the contrary, the structures disposed in a direction opposite to the bending direction with respect to the neutral plane are stretched by bending, and thus receive a tensile force. In addition, since the structures are more vulnerable when receiving a tensile force among the same compressive and tensile forces, there is a higher likelihood of cracks occurring when receiving a tensile force.

The etch stop layer 140 disposed under the neutral plane is compressed and thus may receive a compressive force, and the link line 150 disposed above the neutral plane may receive a tensile force and cracks may occur due to this tensile force. Therefore, the wiring may be located on the neutral plane to minimize or reduce the received tensile force.

By arranging the coating layers 172 and 174 on the bending area BA and the driving circuit area DCA, the neutral plane may be moved upward, and since the neutral plane may be formed at the same location as the wiring or the wiring is located above the neutral plane, the wiring does not receive stress or receives a compressive force during bending, thereby suppressing the occurrence of cracks.

As described below, the first coating layer 174 may be formed in an applying process after bending in the manufacturing process.

The planarization layer 132 may be disposed between the etch stop layer 140 and the first coating layer 174. As can be seen from the above-described cross-sectional view, the link line 150 may be formed on the planarization layer 132, and the FPCs 162 connecting the link lines to the PCB 164 may be disposed.

As shown in FIG. 7, the display device according to the present specification may include the reinforced area EE. The reinforced area EE may be included in the non-display area NDA. The reinforced area EE may be included in the bending area BA but is not limited thereto.

The reinforced area EE may include a separating layer SP disposed above and under the first coating layer 174 and/or the second sealant SEAL2 disposed between the etch stop layer 140 and the second substrate 210. Accordingly, damage to the display device can be prevented or reduced from a spraying pressure caused by an etching fluid sprayed toward the substrates 110 and 120 in a direction from the bottom to top of the display device to form the first etching surface 110b and the second etching surface 120b. For example, the likelihood of the etch stop layer being torn due to the spraying pressure can be reduced.

The reinforced area EE may be formed in a direction in which the etching fluid is sprayed. For example, since the etching fluid is sprayed to form the bending area BA, the reinforced area EE may be disposed to extend in the first direction (e.g., the Y-axis direction) in which the bending area BA is disposed to extend. Accordingly, components disposed in the reinforced area EE may also be disposed to extend in the first direction (e.g., the Y-axis direction) in which the bending area BA is disposed to extend. However, the reinforced area EE is not limited thereto and may be formed in any area on a plane on which the etching fluid is sprayed, as well as on the bending area BA. For example, when cells are separated from a mother glass by performing an etching process and a wheel scribing process, the reinforced area EE may also be formed along a cutting line to protect components disposed above the etch stop layer 140 from the etching fluid used in the etching process.

Referring to FIG. 6, the first coating layer 174, the second coating layer 172, the etch stop layer 140, the link line 150, and the planarization layer 132 may include curved portions in a bent state. In a curved shape, a bending portion of each of the layers 172, 140, 150, 132, and 174 may be defined.

Bending portions 140b, 174b, 132b, and 172b may be disposed in an outer area OA of the first etching surface 110b. The outer area OA may be an area disposed in a direction in which each of the layers 172, 140, 150, 132, and 174 in the bent state from the first end E1 is disposed.

The display device in the bent state may include the first substrate 110 including the first etching surface 110b and the second substrate 210 facing the first substrate 110. In addition, the display device in the bent state may include the second sealant SEAL2 disposed between the first substrate 110 and the second substrate 210. The second sealant SEAL2 may include a 21 sealant SEAL21 disposed in a direction in which the display area DA is disposed with respect to the first end E1 and a 22 sealant SEAL22 disposed in a direction in which the outer area OA is disposed with respect to the first end E1. The 22 sealant SEAL22 may be disposed in the outer area OA of the first etching surface 110b. The 22 sealant SEAL22 may be disposed in the outer area OA of the first end E1.

Various layers 172, 140, 150, 132, and 174 in the bent state may be disposed in the outer area OA of the first etching surface 110b. For example, the etch stop layer 140 including the first bending portion 140b, the first coating layer 174 including the second bending portion 174b, the planarization layer 132 including the third bending portion 132b, and the second coating layer 172 including the fourth bending portion 172b may be disposed in the outer area OA. The third bending portion 132b may be disposed between the first bending portion 140b and the second bending portion 174b. The fourth bending portion 172b may be disposed between the first end E1 and the first bending portion 140b.

The display device in the bent state may include the separating layer SP disposed between the etch stop layer 140 and the second sealant SEAL2. The separating layer SP may include a plurality of layers. The separating layer SP may include a first separating layer SP1 disposed at one side of the first coating layer 174 and a second separating layer SP2 disposed between the first separating layer SP1 and the second sealant SEAL2. The first separating layer SP1 and the second separating layer SP2 may be either connected or separated. The separating layer SP may serve to facilitate bending in a bending process of the display device. The separating layer SP may include a-Si.

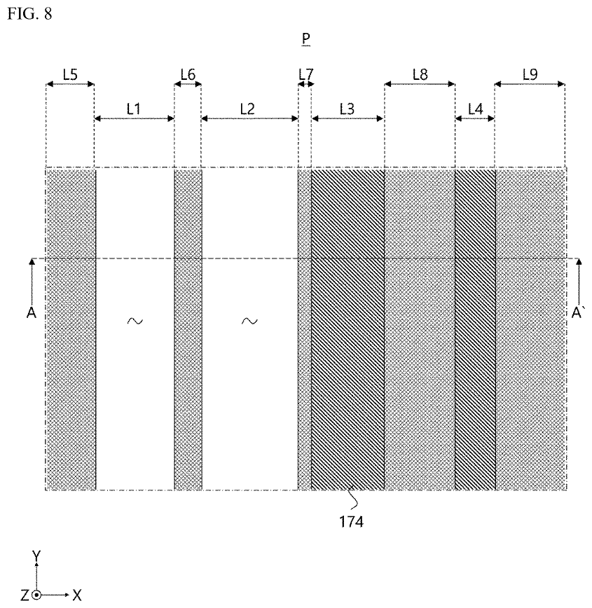

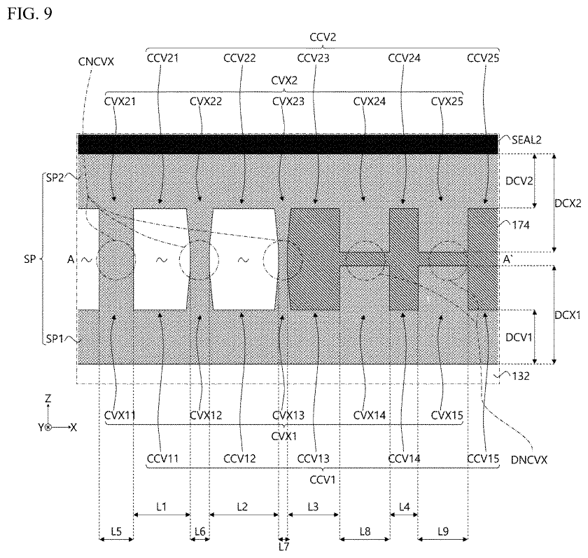

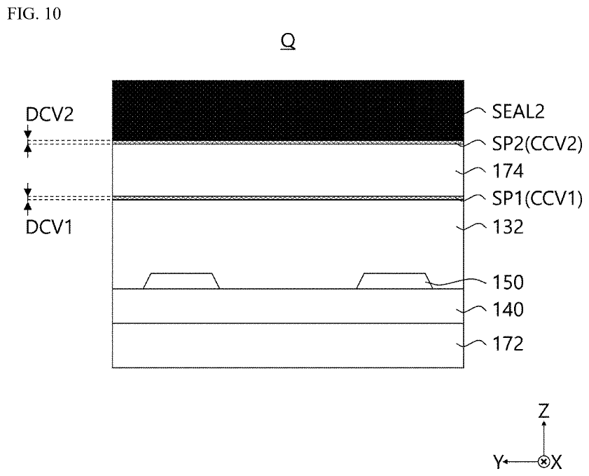

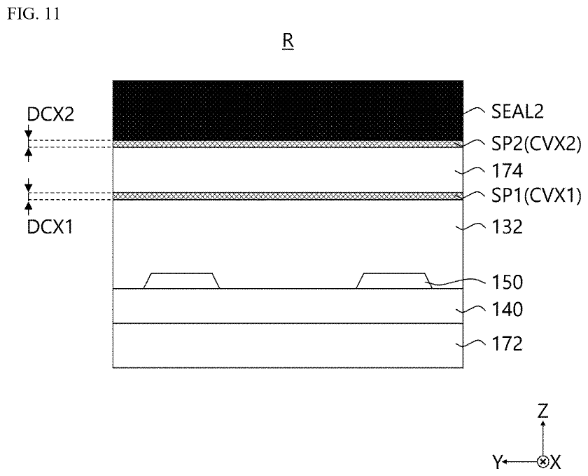

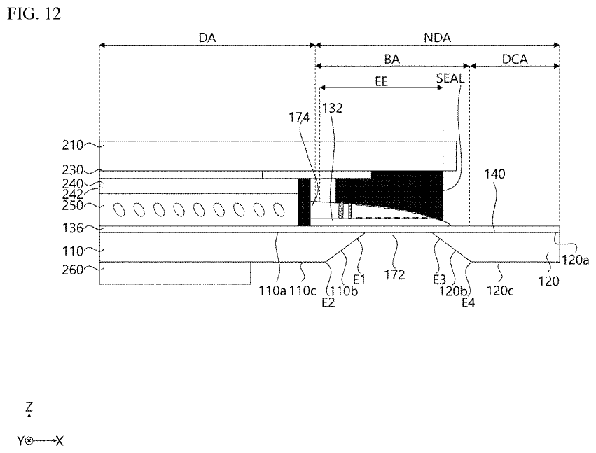

FIG. 8 is an enlarged plan view of portion P of FIG. 6. FIG. 9 is a cross-sectional view along line A-A′ of FIG. 8. FIG. 10 is a cross-sectional view of portion Q of FIG. 7 from another direction. FIG. 11 is a cross-sectional view of portion R of FIG. 7 from another direction. FIG. 12 is a cross-sectional view showing a display device before bending according to a third embodiment of the present specification.

Referring to FIGS. 7 to 12, the separating layer SP may be disposed between the planarization layer 132 and the second sealant SEAL2. As described above, the separating layer SP may include the first separating layer SP1 disposed at one side of the first coating layer 174 and the second separating layer SP2 disposed between the first separating layer SP1 and the second sealant SEAL2.

The separating layer SP may include a portion CNCVX in which the first separating layer SP1 and the second separating layer SP2 are connected. In addition, the separating layer SP may include a portion DNCVX in which the first separating layer SP1 and the second separating layer SP2 are disconnected. In an example embodiment, a case where the display device in the bent state has returned to a state before bending may be shown. Therefore, since a disconnected portion resulting from the bending may still remain, the disconnected portion may be present.

The first separating layer SP1 may include a first convex portion CVX1 that is convex in a direction in which the second separating layer SP2 is disposed and a first concave portion CCV1 that is concave in a direction in which the second separating layer SP2 is disposed. The second separating layer SP2 may include a second convex portion CVX2 that is convex in a direction in which the first separating layer SP1 is disposed and a second concave portion CCV2 that is concave in a direction in which the first separating layer SP1 is disposed. In the separating layer SP, the first concave portion CCV1 and the second concave portion CCV2 or the first convex portion CVX1 and the second convex portion CVX2 may be formed to correspond to each other. For example, the first concave portion CCV1 and the second concave portion CCV2 may be formed to overlap each other in a thickness direction of the display device.

As can be seen in a manufacturing process to be described below, the first concave portion CCV1 and the second concave portion CCV2 may be formed by patterning according to a laser lift off (LLO) process in the separating layer SP initially formed as a single layer.

Note the coordinate axes in FIGS. 8 and 9. FIG. 8 is a plan view corresponding to line A-A′ of FIG. 9.

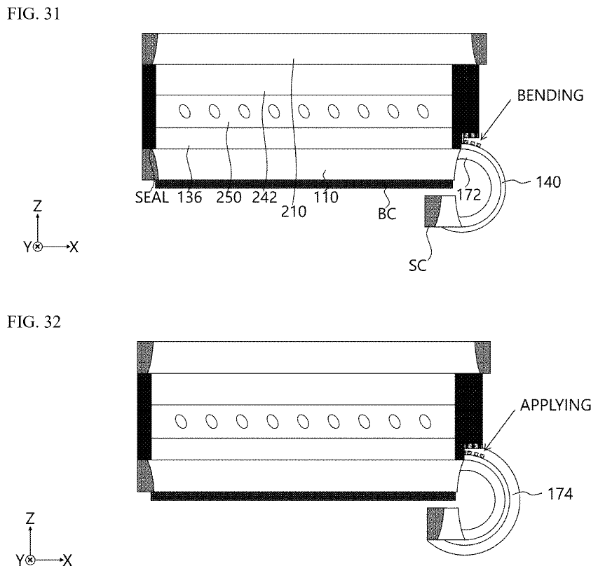

In an example embodiment, an empty space may be created in the separating layer SP by irradiating the separating layer SP with a laser. The empty space is denoted by the symbol “˜”. As shown in FIG. 32 described below, the laser is radiated after both the upper and lower substrates are bonded but may be targeted to only the separating layer SP to cause a chemical reaction. In an example embodiment, the laser may be radiated on the separating layer SP including a-Si and may create the empty space in the separating layer SP. Since the separating layer SP is removed by the laser, the bonding strength between the plurality of separating layers SP1 and SP2 may be weakened. During the bending process, the plurality of separating layers SP1 and SP2 whose bonding strength is weakened may be easily disconnected. The plurality of separating layers SP1 and SP2 may form the disconnecting portion DNCVX and the connecting portion CNCVX.

After the disconnecting portion DNCVX is formed while the separating layer SP is separated during the bending process, the first coating layer 174 may be applied. Therefore, the first coating layer 174 may be disposed between the first separating layer SP1 and the second separating layer SP2. In addition, the first coating layer 174 may be formed only in an area in which the disconnecting portion DNCVX is formed. The first coating layer 174 may not be formed inside an area in which the connecting portion CNCVX is formed. However, in embodiments, the first coating layer 174 may be formed in the empty space.

A direction in which the laser is radiated in the LLO process may be substantially the same as or similar to a direction (e.g., the first direction or the Y-axis direction) in which the bending area BA extends. Therefore, the first concave portion CCV1, the second concave portion CCV2, the first convex portion CVX1, or the second convex portion CVX2 may be formed in the direction in which the bending area BA extends. In addition, the first convex portion CVX1 and the first concave portion CCV1 may be alternately disposed in the second direction (e.g., the X-axis direction). In addition, the second convex portion CVX2 and the second concave portion CCV2 may be alternately disposed in the second direction (e.g., the X-axis direction).

A thickness DCX1 of the first convex portion CVX1 may differ from a thickness DCV1 of the first concave portion CCV1. A thickness DCV2 of the second concave portion CCV2 may differ from a thickness DCX2 of the second convex portion CVX2. A difference in thickness between the concave portion and the convex portion in the same separating layer SP may result from the concave portion formed by the LLO process.

During the bending process, the above-described tensile or compressive force may be applied to the bending portion of the display device. The magnitude of the tensile force applied to the separating layer SP may increase toward the outside (e.g., the X-axis direction) of the display device. As the magnitude of the applied tensile force increases, the initially connected first separating layer SP1 and second separating layer SP2 may receive a force that separates the first separating layer SP1 and second separating layer SP2. Therefore, the plurality of separating layers SP may have different lengths in the thickness direction (e.g., the Z-axis direction).

In addition, since the separating layer SP (e.g., the second separating layer SP2) closer to the second sealant SEAL2 and the separating layer SP (e.g., the first separating layer SP1) farther from the second sealant SEAL2 may not receive the same force while the separating layer SP is separated into a plurality of layers, the thickness DCX1 of the first convex portion CVX1 may differ from the thickness DCX2 of the second convex portion CVX2. For the same reason, the thickness DCV1 of the first concave portion CCV1 may differ from the thickness DCV2 of the second concave portion CCV2.

The separating layer SP may include the connecting portion CNCVX in which the first convex portion CVX1 is connected to the second convex portion CVX2. The separating layer SP may include the disconnecting portion DNCVX in which the first convex portion CVX1 is disconnected from the second convex portion CVX2. In an example embodiment, the disconnecting portion DNCVX may be disposed outside (e.g., the X-axis direction) the connecting portion CNCVX.

As can be seen in the manufacturing process to be described below, the first coating layer 174 may be applied after the disconnecting portion DNCVX is formed while the separating layer SP is separated during the bending process. Therefore, the first coating layer 174 may be disposed between the first separating layer SP1 and the second separating layer SP2. In addition, the first coating layer 174 may be formed only in an area in which the disconnecting portion DNCVX is formed. The first coating layer 174 may not be formed inside an area in which the connecting portion CNCVX is formed.

During the bending process, the above-described tensile or compressive force may be applied to the bending portion of the display device. The magnitude of the tensile force applied to the separating layer SP may increase toward the outside (e.g., the X-axis direction) of the display device. As the magnitude of the applied tensile force increases, the initially connected first separating layer SP1 and second separating layer SP2 may receive a force that separates the first separating layer SP1 and second separating layer SP2. Since the tensile force is no longer applied to the portion DNCVX disconnected by the force, which may be separated during the bending process, a length of the portion DNCVX may be larger than a length of the portion CNCVX to which the tensile force is applied (L8=L9>L5>L6>L7).

In the portion CNCVX that is not disconnected while the tensile force is applied, a length of the separating layer SP in the X-axis direction may gradually decrease toward the outer area of the display device. Therefore, there may be a case where L5>L6>L7. When comparing the lengths of the concave portions formed to be associated with the convex portions, there may be a case where L1<L2.

Regarding L3, L3 is a length of the concave portion and may have an effect of having an increased length due to an influence of L7 that is a length of the convex portion with the smallest length due to receiving the greatest tensile force. In addition, L3 may also have an effect of having a decreased length due to an influence of L8 that is a length of the convex portion with the greatest length due to the formation of the disconnected portion. The length of L3 may be determined by combining all of the above effects.

Comparing L3 and LA, LA may have only the effect of having a decreased length due to L8 and L9 that are lengths of convex portions with increased lengths. In contrast, since L3 also has the effect of having an increased length, L3 may be greater than L4.

Comparing L3 and L2, L2 may have only the effect of an increased length due to L6 and L7 that are lengths of convex portions with decreased lengths. In contrast, since L3 also has the effect of having a decreased length, L2 may be greater than L3.

FIG. 9 is a cross-sectional view showing the separating layer SP in an unbent state, in which the disconnected portion DNCVX has been formed by bending. Assuming a bent state, as described above, the plurality of separating layers SP1 and SP2 may receive a tensile force toward the outer area of the display device. Referring to a 12^{th} convex portion CVX12 and a 13^{th} convex portion CVX13, in each of the convex portions, the portions connected to the separating layers SP1 and SP2 may have a shape with an increased length due to the force toward the outer area. The convex portion may have a tapered shape that becomes thinner toward the center.

The separating layer SP may include an N^{th} convex portion, an N^{th} concave portion disposed in the second direction (e.g., the X-axis direction) from the N^{th} convex portion, an N+1^{th} convex portion disposed in the second direction (e.g., the X-axis direction) from the N^{th} concave portion, and an N+1^{th} concave portion disposed in the second direction (e.g., the X-axis direction) from the N+1^{th} convex portion (N is a natural number of 1 or more). Here, the second direction (e.g., the X-axis direction) may be the X-axis direction. For example, when N is 11, the first separating layer SP1 may include an 11^{th} convex portion CVX11, an 11^{th} concave portion CCV11 disposed in the second direction (e.g., the X-axis direction) from the 11^{th} convex portion CVX11, the 12^{th} convex portion CVX12 disposed in the second direction (e.g., the X-axis direction) from the 11^{th} concave portion CCV11, and a 12^{th} concave portion CCV12 disposed in the second direction (e.g., the X-axis direction) from the 12^{th} convex portion CVX12.

In an example embodiment, a length of the N^{th} convex portion disposed in the second direction (e.g., the X-axis direction) may differ from a length of the N+1^{th} convex portion disposed in the second direction (e.g., the X-axis direction). For example, the length L5 of the 11^{th} convex portion CVX11 disposed in the second direction (e.g., the X-axis direction) may differ from the length L6 of the 12^{th} convex portion CVX12 disposed in the second direction (e.g., the X-axis direction).

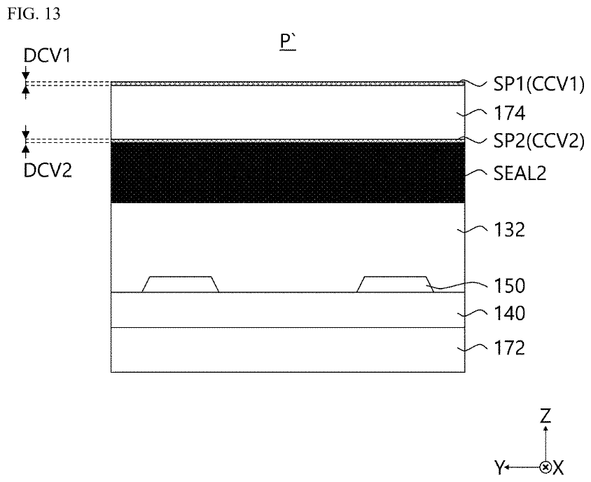

FIG. 13 is a cross-sectional view showing a display device before bending according to a second embodiment of the present specification. FIG. 13 shows portion P′ as a second embodiment of portion P of FIG. 6.

Referring to FIG. 13, the second sealant SEAL2 may be disposed between the first coating layer 174 and the etch stop layer 140. The first separating layer SP1 may be disposed at a first side of the first coating layer 174 and the second separating layer SP2 may be disposed between the first separating layer SP1 and the second sealant SEAL2. Except that locations of the second sealant SEAL2 and the first coating layer 174 are changed, descriptions of the above-described embodiments and other components (e.g., the concave portion, the convex portion, etc.) are substantially the same.

FIGS. 14A to 14C is a set of views for describing an etching process in a manufacturing method of the display device according to an example embodiment of the present specification.

Referring to FIG. 14A, a mask MSK may be disposed on one surface of a substrate SUBS, and an etch stop layer 140 may be disposed on the other surface of the substrate SUBS. A circuit layer, an organic light-emitting layer, etc. may be disposed on the etch stop layer 140, but are omitted for convenience of explanation. The mask MSK and the etch stop layer 140 may be organic films applied or bonded to the substrate SUBS. The etch stop layer 140 may serve as an etch stopper in the etching process. The mask MSK may include an opening exposing the substrate SUBS to a glass etching fluid GEF. The opening of the mask MSK may be formed by laser patterning. A shape, thickness, spacing, etc. of a pattern to be formed on the substrate SUBS may be determined depending on a shape, spacing, and etching process time of the opening. The mask MSK may be removed after the etching process. The substrate SUBS may be etched by spraying the etching fluid GEF on the substrate SUBS on which the mask MSK is bonded or by a dipping method. The etch stop layer 140 may be torn or damaged by the spraying pressure of the etching fluid GEF.

The etching fluid GEF may be supplied to the substrate SUBS through the opening of the mask MSK. The substrate SUBS exposed to the opening of the mask MSK may start to be etched in response to the glass etching fluid GEF.

The glass exposed to the etching fluid GEF is etched to form an opening in the substrate SUBS, and a depth of the opening may become deeper as the etching process time increases.

An operator may control the etching process time (e.g., the time that the substrate SUBS is exposed to the etching fluid GEF) to change a shape of a tapered surface. The final etching surface may be formed in any one of a plurality of shapes shown by controlling the etching process time.

Referring to FIG. 14B as an example, when the etching process time becomes longer in the etching process, the glass etching fluid GEF may penetrate between the substrate SUBS and the etch stop layer 140 and between the substrate SUBS and the mask MSK, thereby forming a tapered surface on the sidewall glass overlapping the opening in a thickness direction of the substrate.

Referring to FIG. 14C as an example, as the etching process time becomes longer, a tapered surface may start to be formed at an edge of the substrate SUBS exposed to the glass etching fluid GEF, and as the process time becomes further longer, the tapered surface may become longer. For example, the etching fluid GEF may also penetrate between the mask MSK and the substrate SUBS to form a tapered surface.

The etching process may be stopped when the designed thickness and cross-sectional shape of the glass substrate are satisfied.

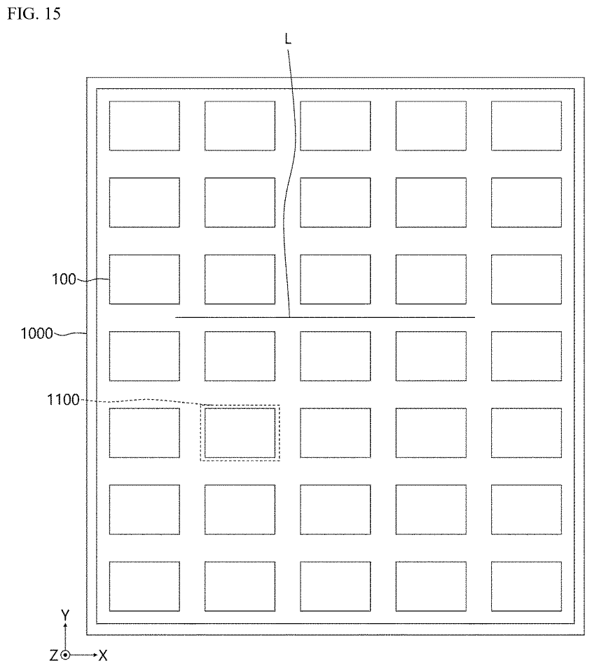

FIG. 15 is a plan view showing a mother glass according to an example embodiment of the present specification.

Referring to FIG. 15, the display device 100 may be formed through a process of forming thin films on a plurality of cells 1100 on a mother glass 1000 that is a large glass substrate. One cell 1100 may correspond to one display panel.

A plurality of display devices 100 may be manufactured simultaneously through a multilayout process to reduce costs and improve productivity. The plurality of cells 1100 may be formed on the mother glass 1000. After the plurality of cells 1100 are formed, a cutting line L may be set on the mother glass 1000. The cutting line L may include a plurality of lines. The cutting line L may be marked by laser patterning as described below. The illustrated cutting line L shows only some lines. Each cell 1100 may be separated (or cut) from the mother glass 1000 based on the cutting line L.

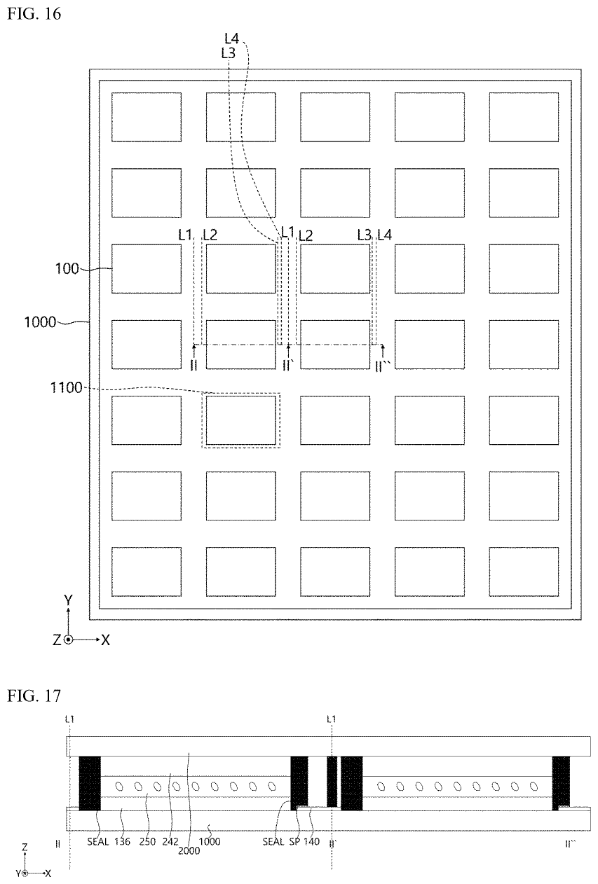

FIGS. 16 to 33 are views for describing a manufacturing method or manufacturing process of the display device according to an example embodiment of the present specification.

Referring to FIG. 16, the mother glass 1000 may include a plurality of virtual lines L1, L2, L3, and L4. A first cutting line L1 may be a cutting line for cell separation, a second cutting line L2 may be a cutting line for bezel length adjustment, a third line L3 may be an etching line for forming a bending area, and a fourth cutting line LA may be a pad portion opening line for opening a pad portion.

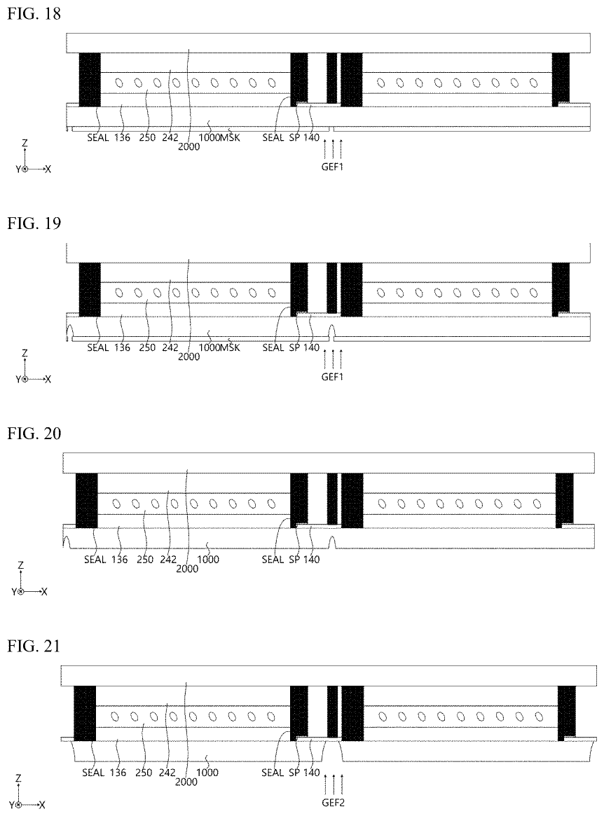

Referring to FIGS. 17 and 18, the lower mother glass 1000 and an upper mother glass 2000 may be bonded by an adhesive layer. A sealant SEAL may be formed between the lower mother glass 1000 and the upper mother glass 2000 corresponding to a line where etching is to be performed. A separating layer SP may be formed between the lower mother glass 1000 and the upper mother glass 2000 corresponding to an area where bending is to be performed.

A mask MSK may be disposed on a rear surface of the lower mother glass 1000. Subsequently, an opening may be formed in the mask MSK by a laser patterning process. The formed opening may correspond to the above-described cutting line.

Referring to FIG. 19, a first glass etching fluid GEF1 may be sprayed into the opening formed in the mask MSK. Accordingly, a hole may be formed in the lower mother glass 1000 overlapping the opening of the mask MSK.

Referring to FIG. 20, the mask disposed on the lower mother glass 1000 may be removed.

Referring to FIG. 21, a second glass etching fluid GEF2 may be sprayed on the lower mother glass 1000. At this time, the opening, which has already been etched by the first glass etching fluid GEF1 and whose thickness has been adjusted, may be continuously etched to become a hole. The hole may have a tapered surface due to the nature of etching or the like, but is not limited thereto.

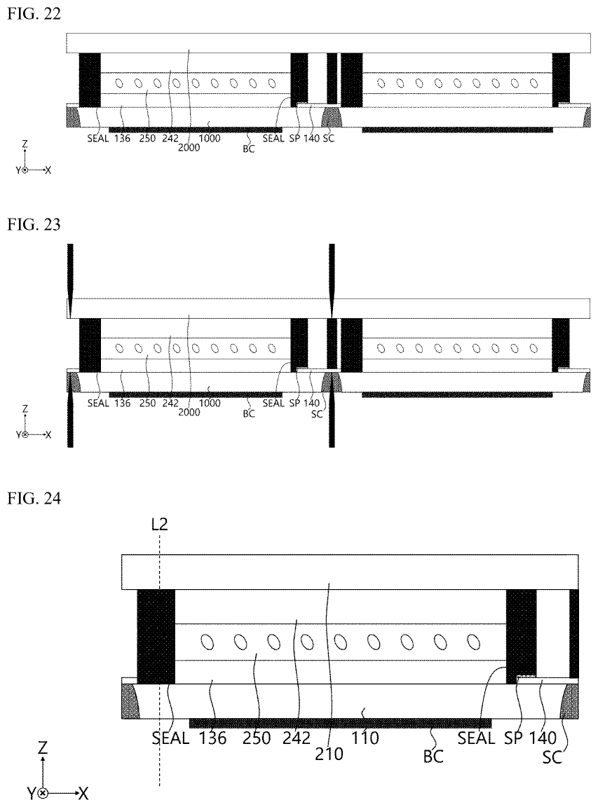

Referring to FIG. 22, a back coating layer BC may be formed on a bottom surface of the lower mother glass 1000. Alternatively, a side coating layer SC may be formed on a tapered surface formed by the second glass etching fluid.

Referring to FIG. 23, the lower mother glass 1000 may be cut. As disclosed, in the manufacturing process of the display device according to the present specification, an etching process may first be performed on the lower mother glass 1000 to perform a process for cell separation in advance. Therefore, there is an advantage in that the likelihood of damage due to a glass step can be reduced compared to a case in which a wheel scribing process for cell separation is performed without the etching process in a bonded state. As a result, production energy can be reduced, thereby achieving process optimization.

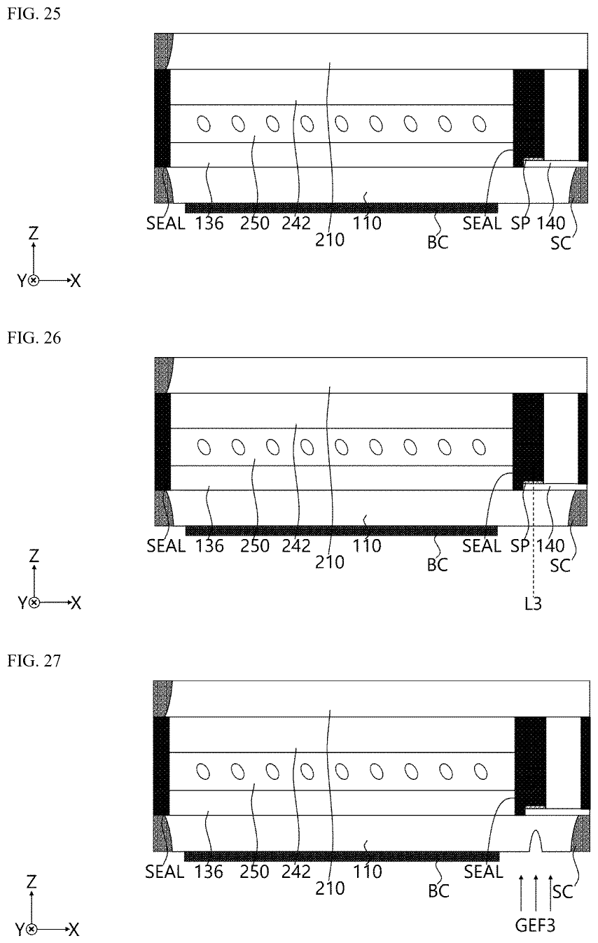

Referring to FIGS. 24 and 25, secondary cutting may be performed along the second cutting line L2 for bezel area length adjustment, etc.

Referring to FIGS. 26 to 28, a hole may be formed in the first substrate 110 to correspond to the area in which bending is performed in a manner that is substantially the same as or similar to the above-described etching process.

Referring to FIG. 29, a second coating layer 172 may be formed to correspond to the formed hole.

Referring to FIG. 30, a process of cutting at least a portion of the second substrate 210 may be performed to open a portion where a pad is located without an adhesive layer. In addition, a concave portion may be formed to facilitate separation during bending by performing an LLO process on the separating layer SP. The LLO process may be referred to as a patterning process for the separating layer SP.

Referring to FIG. 31, a bending process may be performed on the bending area. As a result, portions in which the separation layers are disconnected and connected may be formed.

Referring to FIG. 32, a process of applying the first coating layer 174 on the bent portion may be performed. The applied first coating layer 174 may be applied only up to the separating layer in which the disconnected portion is formed and may not be applied beyond the connected portion. A thickness of the first coating layer 174 applied may be several tens of micrometers. For example, the thickness of the first coating layer 174 may range from 10 μm to 100 μm, or from 20 μm to 90 μm, specifically, from 30 μm to 80 μm, or from 50 μm to 60 μm and more specifically, about 55 μm.

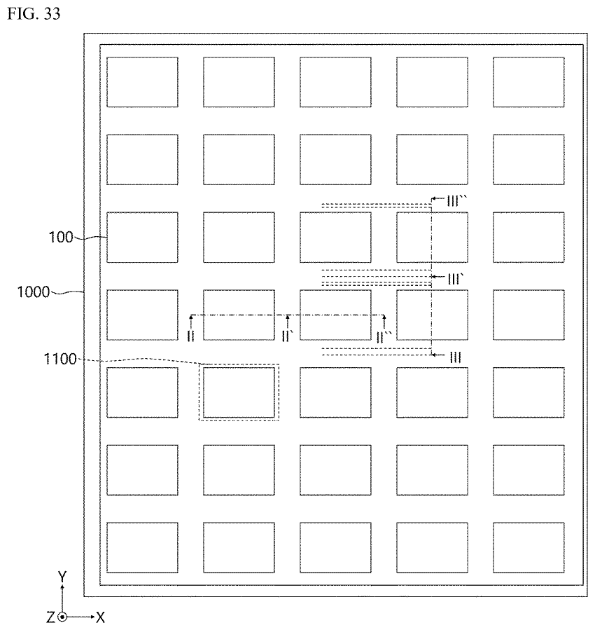

Referring to FIG. 33, the above-described example uses line II-II′-II″ as an example, but may be applied to line III-III′-III″ in substantially the same way. The arrangement of the sealant for reinforcement while spraying the etching fluid, whether the separating layer is applied, etc. may be derived from the present specification within the scope easily conceived by those skilled in the art.

Although embodiments of the present disclosure have been described in more detail with reference to the accompanying drawings, the present disclosure is not necessarily limited to these embodiments, and various modifications may be made without departing from the technical spirit and scope of the present disclosure.

Therefore, the embodiments disclosed in the present disclosure are not intended to limit the technical spirit and scope of the present disclosure but are for illustrative purposes, and the scope of the technical spirit and scope of the present disclosure is not limited by these embodiments.

Therefore, the embodiments described above should be understood in all respects as examples and not restrictive.

The scope of protection of the present disclosure should be interpreted in accordance with the claims, and all technical spirit and scope within the equivalent scope thereof should be interpreted as being included in the scope of rights of the present disclosure.

What is claimed is:

1. A display panel, comprising:
a first substrate including a first etching surface;
a second substrate disposed to face the first substrate; and
a sealant disposed between the first substrate and the second substrate,
wherein the sealant is disposed in an outer area of the first etching surface.

2. The display panel of claim 1, further comprising an etch stop layer including a first bending portion disposed in the outer area.

3. The display panel of claim 2, further comprising a separating layer including a first separating layer and a second separating layer disposed between the first separating layer and the sealant.

4. The display panel of claim 3, further comprising a first coating layer disposed between the first separating layer and the second separating layer,
wherein the first coating layer includes a second bending portion disposed in the outer area.

5. The display panel of claim 4, further comprising a planarization layer including a third bending portion disposed in the outer area,
wherein the third bending portion is disposed between the first bending portion and the second bending portion.

6. The display panel of claim 5, further comprising a second coating layer including a fourth bending portion disposed in the outer area,
wherein the fourth bending portion is disposed between a first end of the first etching surface and the first bending portion.

7. The display panel of claim 3, wherein the first separating layer includes a first convex portion that is convex in a direction in which the second separating layer is disposed and a first concave portion that is concave in the direction in which the second separating layer is disposed, and
the second separating layer includes a second convex portion that is convex in a direction in which the first separating layer is disposed and a second concave portion that is concave in the direction in which the first separating layer is disposed.

8. The display panel of claim 7, further comprising a connecting portion in which the first convex portion is connected to the second convex portion.

9. The display panel of claim 8, further comprising a disconnecting portion in which the first convex portion and the second convex portion are disconnected,
wherein a length of the connecting portion differs from a length of the disconnecting portion.

10. The display panel of claim 7, further comprising a first coating layer disposed between the first convex portion and the second convex portion.

11. A display panel, comprising:
a bending area;
a display area including a thin film transistor;
a first substrate;
a second substrate disposed to face the first substrate;
an etch stop layer disposed in the bending area; and
a sealant disposed between the first substrate and the second substrate,
wherein the sealant includes:
a first sealant disposed in the display area; and
a second sealant disposed between the etch stop layer and the second substrate.

12. The display panel of claim 11, further comprising a separating layer disposed between the etch stop layer and the second sealant.

13. The display panel of claim 12, further comprising a first coating layer disposed between the etch stop layer and the second substrate,
wherein the separating layer includes a first separating layer disposed at one side of the first coating layer and a second separating layer disposed between the first separating layer and the sealant.

14. The display panel of claim 13, wherein the first separating layer includes a first convex portion that is convex in a direction in which the second separating layer is disposed and a first concave portion that is concave in the direction in which the second separating layer is disposed, and
the second separating layer includes a second convex portion that is convex in a direction in which the first separating layer is disposed and a second concave portion that is concave in the direction in which the first separating layer is disposed.

15. The display panel of claim 14, wherein a thickness of the first convex portion differs from a thickness of the second convex portion, and
a thickness of the first concave portion differs from a thickness of the second concave portion.

16. A display device, comprising:
a display area for displaying an image;
a driving circuit area including a driving circuit for driving the display area; and
a non-display area including a bending area disposed to extend in a first direction,
wherein:
the bending area includes an etch stop layer disposed to extend in the first direction, and
a separating layer disposed to extend in the first direction; and
the separating layer includes a concave portion disposed to extend in the first direction.

17. The display device of claim 16, wherein the separating layer includes a convex portion disposed to extend in the first direction, and
the convex portion and the concave portion are alternately disposed in a second direction intersecting the first direction.

18. The display device of claim 17, wherein the separating layer includes an N^{th} convex portion, an N^{th} concave portion disposed in the second direction from the N^{th} convex portion, an N+1^{th} convex portion disposed in the second direction from the N^{th} concave portion, and an N+1^{th} concave portion disposed in the second direction from the N+1^{th} convex portion, where N is a natural number of 1 or more, and
a length of the N^{th} convex portion disposed in the second direction differs from a length of the N+1^{th} convex portion disposed in the second direction.

19. The display device of claim 16, wherein the bending area includes a sealant disposed to extend in the first direction.

20. The display device of claim 19, wherein the separating layer is disposed between the etch stop layer and the sealant.
